(19) United States
(12) Patent Application Publication
(10) Pub. No.: US 2006/0277725 A1
(43) Pub. Date: Dec. 14, 2006

(54) Clip for clipping sheets together

(76) Inventor: Peter Weingartner, Wien (AT)

Correspondence Address: KOLISCH HARTWELL, P.C., 200 PACIFIC BUILDING, 520 SW YAMHILL STREET, PORTLAND, OR, 97204, US

(21) Appl. No.: 10/550,478

(22) PCT Filed: Feb. 18, 2004
(86) PCT No.: PCT/AT04/00047

§ 371 Date: Aug. 7, 2006

(30) Foreign Application Priority Data
Mar. 24, 2003 (AT) A 465/2003

(51) Int. Cl. B42F 1/00

(52) U.S. Cl. 24/67 R

(57) ABSTRACT

The invention relates to a clip for clipping together sheets which are made of paper, plastic, metal etc, on the corners or sides thereof. Said clip is U-shaped and comprises two similar or different limps. The stack of paper is clipped together between said two limps or by means of projections incorporated therein. The invention is characterised in that said clip is embodied as a triangular single piece or is trapezium-shaped or is shaped like a semi-circle or is semi-elliptically shapes with limpbs (1, 1a or 1b) which are arranged parallel to each other when in the rest position. The two limbs (1, 1a or 1b) comprise a small fold (3), which is inwardly curved an which bends to form an acute or obtuse angle (3a), on each side (4) forming an acute angle or an obtuse angle (4a) with the back (2) or on each vertex (8). The two limbs (6) are arranged on top of each, parallel to each other and are connected together without mutual contact by means of a spring (7) boht in a rest position and also in a position wherein a stack of sheets is clipped. The clip is displaced in the direction of the edge (4) or the back (2) on the stack of paper and is clipped by the pre-tensed back (2) or the spring (7) on the folds (3) which are inwardly curved.

This invention concerns a clip for clamping sheets according to the preamble of claim 1. There are several kinds of clips of differently designs in principle:

On the one hand staples, which perforate the paper and which can only be removed with difficulty and on the other hand clips based on friction, which can in turn essentially be divided into two groups, i.e.: paper clips consisting of a piece of wire, plastic or sheet metal or spring-loaded clamping devices with attached handles.

In the case of the conventional paper clip and the sheet metal clamp, the latter group of clips, which are based on a clamping effect, have the disadvantage of low holding ability, while, due to the necessary handles, the other devices are cumbersome, multipart and bulky and also of only limited functionality, since the closing and opening mechanism is not separated from the clipping mechanism.

The one-piece clips of WO 2001/58700A, DE 42 39 544A, U.S. Pat. No. 5,970,777A, GB 1 206 538A, DE 381 81° C. have two faults:
1. Those, which can be easily slipped onto a stack of sheets, only have low clamping power due to the material or because they clamp by means of surfaces.
2. The only clip with high clamping power (WO 01/58700A) is however very difficult to remove from the stack.

This invention aims to provide remedial measures and to disclose a clip wherewith the sheets that are to be held together are pressed directly against each other and are fixed, without damaging the sheets, by means of spring-loaded triangular or trapezoidal or semicircular or semielliptical limbs and by inwardly bent folds. The clamping effect of this clip is almost comparable with that of a positive locking clip. According to this invention, these goals are achieved by means of the technical features characterized in claims 1 to 3.

The invention is described in greater detail in the following by means of the drawings.

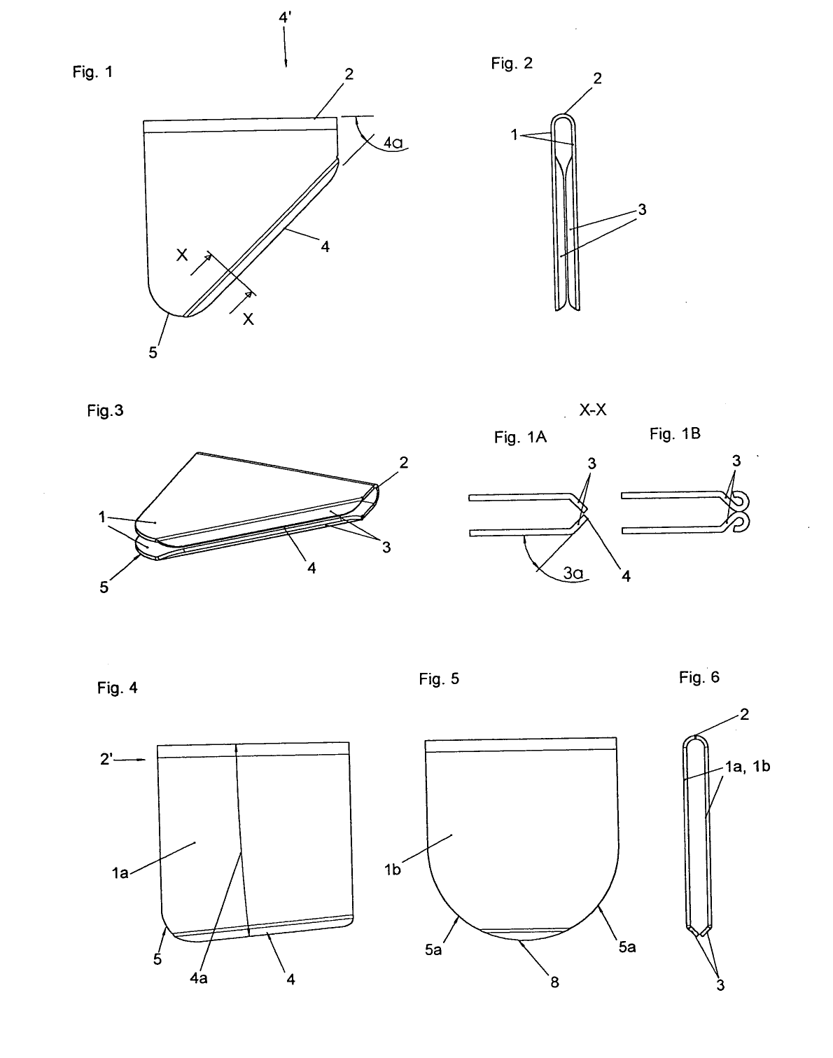

FIGS. 1-3 show a triangular form of a one-piece clip of this invention. FIG. 1 shows this clip in horizontal projection, FIG. 2 in lateral projection and FIG. 3 in oblique projection.

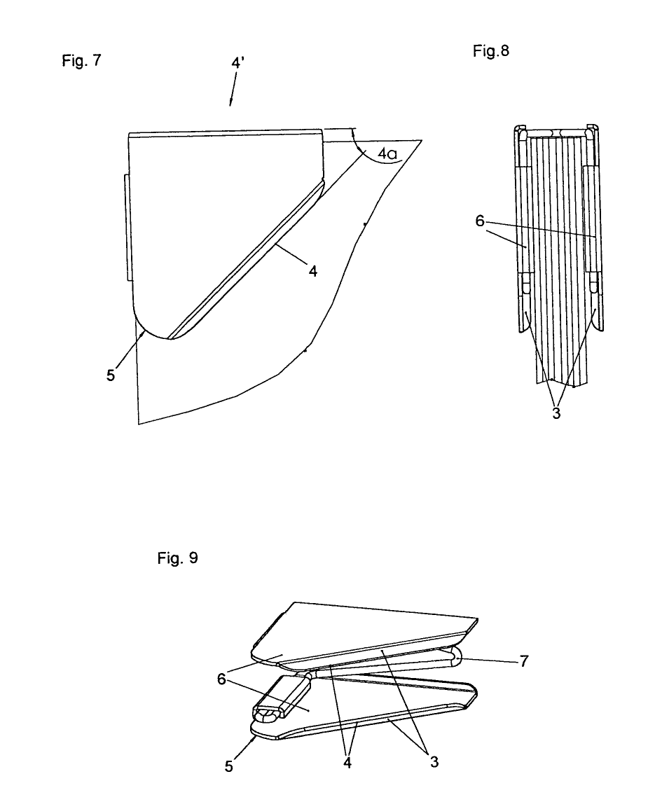

FIGS. 4-6 show a trapezoidal and semicircular design of the clips of FIGS. 1-3.

FIGS. 7-9 show a multipart clip of this invention, whose limbs are almost identical with that of FIGS. 1-3.

The clip, as represented in FIGS. 1-6, has two mirror-image limbs 1, 1a, 1b, which are connected with each other so as to swivel elastically along a back 2. Since the clip is intended to grasp the paper stack on one corner and since the stack must be easily separable, the limbs 1, 1a, 1b are made to be triangular or trapezoidal or semicircular or semielliptical.

The clip, as shown in FIG. 7-9 has two limbs 6, which are movably connected with one another by a spring 7 such that, both in the relaxed state of the clip and in the state in which a stack of sheets is clamped, both limbs 6 are located on top of each other and parallel to each other, without mutual contact.

As shown in FIG. 1A and FIG. 1B, the inwardly curved folds 3 are respectively located on one side 4 of the two limbs 1, 1a, 6 (FIGS. 1, 4, 7) arranged at an acute or obtuse angle 4a with respect to the back 2 or in the region of the vertex 8 of the two limbs 1b (FIG. 5). The clip is neither opened nor closed, it is only applied to the paper stack with the curve 5 of the limbs 1, 1a, 6 or with the curve 5a of the limbs 1b and pushed over the paper stack by finger pressure 4′, 2′ in the direction of the edge 4 or toward the back 2. It is removed by pushing in the direction opposite to 4′ or 2′.

An absolutely reliable stop of the clamped sheets is ensured by the fold 3 which is beveled at an angle 3a. This clip can be made of metal, plastic, wood or paper.

1. Clip for clamping sheets of paper, plastic, metal etc. at their corners or sides, which is configured U shaped, one-piece or multipart with two limbs of the same or different shape, with the stack of sheets being clamped between both limbs, by these alone or by means of projections incorporated into them and the force of the pre-tensioned back, characterized by the fact that it is configured one-piece triangular or trapezoidal or semicircular or semielliptical with limbs (1, 1a or 1b) that are arranged parallel to each other when in the relaxed state, with both limbs (1, 1a or 1b) comprising a small fold (3), which is inwardly curved and which bends to form an acute or obtuse angle (3a), on each side (4) forming an acute or obtuse angle (4a) with the back (2) or on each vertex (8), and that it consists of metal or high-strength plastic or wood or compressed cellulose.

2. Clip according to claim 1, characterized by the fact that, both in the relaxed state of the clip and in the state with a clamped stack of sheets, both limbs (6) are arranged on top of each other and parallel to each other by means of a spring (7).

3. Clip according to claim 1, characterized by the fact that it is made to be multipart, with both limbs (6) being connected by means of a spring (7) without making mutual contact.
